(19) United States
(12) Patent Application Publication
(10) Pub. No.: US 2005/0176899 A1
(43) Pub. Date: Aug. 11, 2005

(54) Mannich bases from isolated amine adducts

(75) Inventor: Jorg Volle, Selm-Bork (DE)

Correspondence Address: PROSKAUER ROSE LLP;PATENT DEPARTMENT, 1585 BROADWAY, NEW YORK, NY, 10036-8299, US

(73) Assignee: Huntsman Advanced Materials Americas, Inc., Brewster, NY (US)

(21) Appl. No.: 10/512,594

(22) PCT Filed: Apr. 16, 2003
(86) PCT No.: PCT/EP03/50107

(30) Foreign Application Priority Data
Apr. 29, 2002 (DE) 102 19 102.6

(51) Int. Cl. C08G 59/14

(52) U.S. Cl. 525/525; 564/355

(57) ABSTRACT

Mannich bases as curing agents for epoxy resins, characterized in that to prepare the Mannich base an isolated amine adduct is used obtainable by reacting a) an amine containing at least three active amine hydrogens with b) an epoxide compound containing on average one or more than one epoxide group in the molecule, optionally using a solvent, there being an excess of a) relative to reactive groups of components a) and b), and subsequently the adduct formed is isolated from free amines. Curable epoxy resin compositions comprising these Mannich bases are suitable owing to good obtainable surface properties in particular for coating, adhesively bonding and enhancing metallic and mineral substrates, as adhesive and sealant, and for producing mouldings and sheetlike structures.

The present Invention relates to Mannich bases prepared using isolated amine adducts obtainable by reacting amines with epoxide compounds and then isolating the adducts from free amines; in particular, in one preferred embodiment, the preparation of Mannich bases by transaminating the aforementioned isolated amine adducts with Mannich bases; and to the use of these Mannich bases as curing agents for epoxy resins.

Curable compositions based on amine compounds and epoxy resins have long been used in industry for coating and enhancing metallic and mineral surfaces, and also as adhesives and sealants. The cure rate of such systems is too low for many applications, particularly when coating is to be carried out at low temperatures, e.g. in winter. Numerous experiments have been performed aimed at achieving sufficient low-temperature curing through the addition of external accelerators. Use has been made, for example, of tertiary amines and phenols, with preference being given to tertiary amines such as trisdimethylaminomethylphenol, for example. However, since these external accelerators do not participate in the curing reaction, they are subsequently present in free form in the cured thermoset and can be washed out later on. Moreover, free phenols in particular are toxicologically objectionable. For this reason it is common to use reaction products of phenols, aldehydes and amine compounds as curatives or accelerators. The thermosets cured with epoxide compounds, however, generally have poor surface qualities. Thus, greasy films, formation of hydrates and development of texture are frequent occurrences, meaning that such Mannich bases can often not be used in the surface sector. The subsequent formation of adducts of the abovementioned compounds, although possibly contributing to improving the level of properties, is unable to eliminate these surface defects completely. The fraction of free residual amines results, moreover, in the abovementioned compounds having a strong odour nuisance effect and in some cases being toxicologically objectionable.

It was an object of the present invention, therefore, to provide curing agents which have a sufficient cure rate at low temperatures in combination with as long a pot life as possible and, at the same time, satisfactory surface qualities such as, for example, a low propensity to form texture or greasy films. This object is achieved in accordance with the invention through the use of specially prepared Mannich bases based on isolated amine adducts as curatives for epoxy resins. These Mannich bases are obtainable by reacting an amine with aldehydes and phenols, characterized in that first of all, before the amine is reacted with the aldehyde and the phenol component, in a first step an adduct is formed from the amine with a preferably monofunctional compound, and this adduct is then isolated. This isolated adduct, in a second step, is reacted conventionally to form a Mannich base or, alternatively, is used for the transamination of a Mannich base starting compound.

Surprisingly, the use of these specially prepared Mannich bases as curing agents for epoxy resins leads to surface properties in the cured products which, comparatively, are much better than when using Mannich bases with a comparable degree of adduct formation but prepared not from amine adducts isolated to start with but rather from subsequent adducts of Mannich bases.

The isolated amine adducts are prepared using epoxide compounds, preferably monofunctional glycidyl ethers, such as phenyl glycidyl ether, cresyl glycidyl ether, glycidyl ethers based on distilled cashew nut shell oil, glycidyl ethers based on monoalcohols, styrene oxide, etc.

Amine compounds used are those amines which contain at least 3 active hydrogen atoms in the molecule. Preferred amines are polyalkylenamines, especially polyethylenepolyamines such as, for example, aminoethylpiperazine, ethylenediamine, diethylenetriamine, triethylenetetramine and tetraethylenepentamine.

To prepare the isolated amine adducts the epoxide compound is added to a 1.5 to 8 molar, preferably 2 to 3 molar, excess of the amine component at from 60° C. to 80° C. with stirring and, after reaction has taken place, the excess of amine compound is separated off by distillation, where appropriate under reduced pressure, to give a product isolated from free amines.

The isolated adducts, in particular those with monofunctional epoxide compounds, are liquid at room temperature.

As a phenol component for preparing the Mannich bases it is possible, for example, to use the following: monophenols, such as phenol, cresol, the isomeric xylenols, para-tert-butylphenol, nonylphenol, naphthols and also diphenols and polyphenols such as resorcinol, hydroquinone, bisphenol A, bispenol F or novolaks.

As an aldehyde component it is preferred to use trioxane, formaldehyde or paraformaldehyde.

The Mannich bases are prepared from the isolated amine compounds by methods known per se, by introducing the isolated amine adduct compound with the phenol component, where appropriate in the presence of diluents and/or solvents, and adding the aldehyde component in portions at elevated temperature, dissolving it, and, after heating up to 160° C., separating off the water of reaction. Examples of diluents and/or solvents which can be used include the following: xylene, toluene, alcohols, ethers, water. The nature of the diluents/solvents used is dependent on the dissolution capacity of the reactants. Thus, depending on the isolated adducts or phenols employed, the solubility may be better in one or another solvent. Good results are essentially obtained using xylene as solvent.

This invention firstly provides, therefore, Mannich bases characterized in that to prepare the Mannich bases an isolated amine adduct is used obtainable by reacting a) an amine containing at least three active amine hydrogens with b) an epoxide compound containing on average one or more than one epoxide group in the molecule, optionally using a solvent, there being an excess of a) relative to reactive groups of components a) and b), and subsequently the adduct formed is isolated from free amines.

The invention further provides Mannich bases characterized in that for the preparation of the Mannich base from an amine, an aldehyde and a phenol derivative the amine used is an isolated amine adduct obtainable as described above.

For the preparation of the Mannich bases, in addition to the isolated adducts, it is also possible to use as well, in part, polyamidoamides with or without imidazoline groups, prepared from polyamine compounds and organic acids.

One particularly preferred embodiment of the invention are Mannich bases characterized in that for the preparation of the Mannich bases a Mannich base obtained by reacting an amine, an aldehyde and a phenol derivative is subjected to transamination with an isolated amine adduct of the invention.

Mannich bases prepared by transamination are described in, for example, DE-A 28 05 853 and in EP-A 0 684 268. The advantage of these compounds is their extremely low phenol content and hence a lower toxicity. In such a transamination reaction amine compounds are exchanged for amine compounds of a Mannich base, preferably mono, bis- or tris(dimethylamino)phenol, by heating both components to more than 110° C., in the course of which the secondary amine compound present on the phenol component, generally dimethylamine, is eliminated and removed from the reaction mixture by distillation. Also described therein are adducts of such exchange Mannich bases with various compounds, particularly glycidyl ethers. The disadvantage of such compounds, here again, is the still considerable fraction of free, unreacted amine. The source of this free amine fraction is the linkage products which are also formed, in accordance with the following scheme (using a diamine and dimethylaminomethylphenol by way of example): 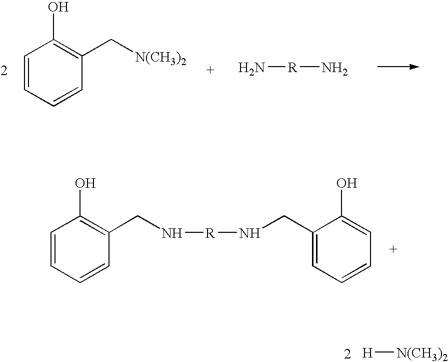
where the dimethylamine, HN—(CH₃)₂, leaves the reaction mixture at the temperatures customary during the transamination reaction and is collected in a cold trap. The unreacted residues of the normally low-volatility amine compounds used for the transamination remain in the product.

Free amines, however, have an intense odour and are thus a nuisance during processing, particularly in enclosed areas, and are frequently toxicologically objectionable. The aim of the invention was to eliminate the aforementioned disadvantages here as well and to provide curing agents which cure rapidly at low temperatures (<5° C.) and have a low free amine content.

This object has been achieved through the curing agents of the invention, which are characterized in that, as already described above, in a first step an isolated adduct of an amine compound with an epoxide compound is prepared and, in a second step, this adduct is subjected to a transamination reaction with a Mannich base, the isolated amine adduct adding to the phenol of the Mannich base and being exchanged for the amine, preferably a secondary amine, which is present on the phenol.

Moreover, such products, particularly when tris(dimethylaminomethyl)phenol is used, have a very low phenol content. In addition to the isolated amine adducts it is also possible to prepare the Mannich bases in part from polyaminoamide compounds prepared from polyamines and organic acids.

The invention accordingly further provides curing agents for epoxide compounds, obtainable from isolated amine adducts and Mannich bases by means of a transamination reaction.

The Mannich bases needed to prepare the compounds of the invention are preferably Mannich bases of phenol, formaldehyde and dimethylamine, which are available commercially, for example, from the company Rohm & Haas under the name DMP. These products include DMP 10 or (dimethylaminomethyl)phenol, DMP20 or bis(dimethylaminomethyl)phenol and DMP 30 or tris(dimethylaminomethyl)phenol. Preference is given here to tris(dimethylaminomethyl)phenol. Tris(dimethylaminomethyl)phenol is also available commercially from Vantico as curative HY-960-1 CH. There is no need to make special mention of the fact that Mannich bases based on other phenols (e.g. bisphenol A or bisphenol F, cresol etc), aldehydes and amine compounds can also be used.

The degree of transamination is guided by the desired properties of the compounds of the invention. It can be between 1% and 100%. That is, between 1% and 100% of the amino groups, preferably secondary amino groups, that are present on the Mannich base used can be exchanged. This must be viewed as a function of the degree of substitution of the Mannich base employed. For example, in the case of bis (dimethylaminomethyl)phenol only one amino group can be exchanged, while in the case of bis(dimethylaminomethyl)phenol a maximum of 2 amino groups and in the case of tris(dimethylaminomethyl) phenol a maximum of 3 amino groups can be exchanged. Preferred in accordance with the invention are compounds in which the amino groups have not been completed exchanged. Taking tris(dimethylaminomethyl)phenol as the example, these are compounds containing unexchanged dimethylamine groups.

Particular preference is given to transamination products based on trisdimethylaminomethylphenol in which the degree of exchange is from 50% to 99%, more preferably from 60% to 95%. The isolated amine adducts used to prepare the compounds of the invention have been described above.

The compounds of the invention obtained by transamination may additionally have adducts formed from them with compounds capable of reaction with amine compounds, for the purpose of establishing specific properties or setting the amine equivalent. For this purpose it is also possible in particular to use the compounds used for forming adducts of the amine compounds.

The invention further provides curable compositions comprising a Mannich base of the invention, an epoxy resin, and, optionally, the auxiliaries and additives that are customary in epoxy resin chemistry.

The invention further provides for the use of the curable compositions for coating, adhesively bonding and enhancing metallic and mineral substrates, as adhesive and sealant, and also for producing mouldings and sheetlike structures.

### EXAMPLES

### Example 1

### Preparation of an Isolated Adduct

567 g of tetraethylenepentamine TEPA (3 mol) are charged to a reaction vessel. After heating to about 60° C., 185 g of cresyl glycidyl ether (1 epoxide equivalent) are added over the course of about 60 minutes. The temperature rises to 90° C. The reaction product is then heated to 260° C. and the excess amine is separated off under reduced pressure (<1 mbar) . Distillate: 380 g (2 mol) of TEPA. Viscosity/25° C.: 1500 mPa.s (Haake rotational viscometer VT 550).

### Example 2

### Preparation of a Mannich Base from an Isolated Adduct

374 g (about 1 mol) of the isolated adduct from Example 1 are charged to a reaction vessel together with 31.3 g of phenol (0.33 mol) and 200 g of xylene and the initial charge is homogenised. Then, after heating to 60° C., 30 g (1 mol) of paraformaldehyde are added in portions at not more than 90° C., and dissolved. After heating to 150° C., the water of reaction formed (18 g) is separated off using a water separator. When the total amount of water has been separated off the xylene is separated off under a reduced pressure of 50 mbar. This gives a yellowish product of high viscosity.

A) 70 g of the product is dissolved in 24 g of xylene and 6 of butanol. The 70% solution has a viscosity of 3400 mPa.s.

B) 70 g of the product are dissolved in 30 g of benzyl alcohol. The 70% solution has a viscosity 13100 mPa.s.

The theoretical amine equivalent of the solutions is approximately 120.

### Example 3

### Transamination

561 g (about 1.5 mol) of the isolated adduct from Example 1 are homogenised with 265 g of DMP 30 (about 1 mol) and heated at 145° C. in a distillation apparatus with distillate cooling until 67.5 g of distillate have been eliminated. (This corresponds to a degree of transamination of 50%, based on all of the substitution possibilities.) Analysis by gas chromatography reveals the distillate to be pure dimethylamine. The amount of distillate corresponds to 1.5 mol of dimethylamine.

Cooling gives a yellowish product of high viscosity.

A) 70 g of the product are dissolved in 24 g of xylene and 6 g of n-butanol. The 70% solution has a viscosity of 2000 mPa.s.

B) 70 g of the product are dissolved in 30 g of benzyl alcohol. The 70% solution has a viscosity of 8700 mPa.s.

The theoretical amine equivalent of the solutions is approximately 145.

### Example 4

### Transamination

748 g (about 2 mol) of the isolated adduct from Example 1 are reacted in accordance with Example 2 with 265 g (1 mol) of DMP 30 until 90 g (2 mol) of dimethylamine have been eliminated.

(Degree of transamination 66%).

A) 70 g of the product are dissolved in 24 g of xylene and 6 of n-butanol. The 70% solution has a viscosity of 3200 mPa.s.

B) 70 g of the product are dissolved in 30 g of benzyl alcohol. The 70% solution has a viscosity of 14400 mPa.s.

The theoretical amine equivalent of the solutions is approximately 132.

### Example 5

### Subsequent Adduct Formation

100 g of the solution from Example 4 are heated to 70° C. and an adduct is subsequently formed with 5 g of cresyl glycidyl ether (epoxide equivalent 182). The product has a viscosity of 18800 mPa.s. The theoretical amine equivalent is approximately 145.

### Example 6

### Comparative Example to Example 4, Adduct Formed Subsequently from Exchanged Mannich Base, Same Amounts Employed

378 g (2 mol) of tetraethylenepentamine are reacted in accordance with Example 2 with 265 (1 mol) of DMP 30 (tris(dimethylaminomethyl)phenol) until 90 g (2 mol) of dimethylamine have been eliminated (degree of transamination 66%). An adduct is subsequently formed from the product using 370 g of cresyl glycidyl ether at from 80° C. to 100° C.

A) 70 g of the product are dissolved in 24 g of xylene and 6 g of n-butanol. 70% solution has a viscosity 3800 mPa.s.

B) 70 g of the product are dissolved in 30 g of benzyl alcohol. The product has a viscosity of 16500 mPa.s.

The theoretical amine equivalent is approximately 132.

### Example 7

### Use Example, Surface Comparison

The solutions A) of the compounds of the invention from Examples 2 to 6 are homogenised with a bisphenyl A diglycidyl ether (epoxide equivalent: 185) Araldite GY 250 (Vantico AG) and a portion of the mixture is applied to a glass plate using a 100μ spiral and stored in a controlled-climate cabinet at 5° C. for 24 hours. An assessment is made of the surface quality. The amounts and results are given in Table 1.

TABLE 1
The surfaces are assessed on a scale from 1 to 10, where
1 denotes the best and 10 the worst evaluation. Water spotting
is tested by applying water to the coating. A visual evaluation
is made of the whitening of the film after 1 hour. Greasy film
and sticking are determined by touch-testing the surface by hand,
wearing a rubber glove for protection. The formation of
hydrates is likewise assessed visually.

| | g curing | a) | | c) | | |
|---|---|---|---|---|---|---|
| Example | agent per | Water | b) | Hydrate | d) | Sum |
| A) | 100 g Araldite | spotting, | Greasy | form- | Stick- | of a) |
| solutions | GY 250 | 1 h | film | ation | ing | to d) |
| 2 | 65 | 4 | 3 | 4 | 5 | 16 |
| 3 | 78 | 3 | 3 | 3 | 4 | 13 |
| 4 | 71 | 3 | 3 | 3 | 4 | 13 |
| 5 | 78 | 2 | 2 | 2 | 3 | 9 |
| 6 | 71 | 6 | 3 | 6 | 4 | 19 |

### Example 8

### Use Example, Cure Rate

The solutions B) of the compounds of the invention from Examples 2 to 6 are homogenised with a mixture of a bisphenol A/F diglycidyl ether with a glycidylised fatty alcohol (epoxide equivalent of 194 g) Araldite GY 793 (Vantico). A portion of this mixture is poured into a sample vessel with a thickness of 6 mm and stored in a controlled-climate chamber at 5° C. A measurement is made of the cure rate to Shore D. The results are set out in Table 2.

TABLE 2

| Example B) | g curing agent per | | | | |
|---|---|---|---|---|---|
| solutions | 100 g Araldite GY 793 | 1 day | 2 days | 3 days | 7 days |
| 2 | 62 | 25 | 48 | 67 | 75 |
| 3 | 75 | 34 | 56 | 74 | 76 |
| 4 | 68 | 30 | 52 | 69 | 74 |
| 5 | 75 | 37 | 60 | 76 | 78 |
| 6 | 68 | 29 | 52 | 70 | 77 |

Discussion of the Results:

The cure rates of the products are comparable. As compared with the preferred embodiment of the transaminated products (Examples 3 to 5) the specimen cast with the directly prepared Mannich base (Example 6) has a somewhat lower initial hardness.

The surfaces of the products of the invention (Examples 2 to 5) surprisingly exhibit a lower level of hydrate formation and of water spotting than comparative Example 6. This is also evident from the direct comparison of Examples 4 and 6. This result was unforeseeable, since the reactants in these two products are present in equal amount and differ only in that, in the example according to the invention, an isolated adduct is used to prepare the Mannich base, and the comparative example is subsequently adducted with the same amount of glycidyl ether. A striking finding is the further significantly improved surface quality and somewhat better cure rate of the inventive Example 5. Also surprising is the viscosity of the inventive Example 4, which is lower by about 15% in direct comparison with comparative Example 6.

1-11. (canceled)

12. A process for producing a Mannich Base comprising the steps of:
1. forming an isolated amine adduct;
2. reacting the isolated amine adduct with an aldehyde component and a phenol component.

13. The process of claim 12, wherein the isolated amine adduct is formed by reacting (a) an amine compound containing at least three active amine hydrogens with (b) an epoxide compound, there being an excess of (a) relative to reactive groups of components (a) and (b), and thereafter separating off the excess amine compound to yield an adduct isolated from free amines.

14. The process of claim 13, wherein the epoxide compound is a monofunctional glycidyl ether.

15. The process of claim 13, wherein the amine compound is a polyalkylenamine.

16. The process of claim 15, wherein the amine compound is a polyethylenepolyamine.

17. The process of claim 13, wherein the epoxide compound is added to a 1.5 to 8 molar excess of the amine component.

18. The process of claim 17, wherein the epoxide compound is added to a 2 to 3 molar excess of the amine component.

19. A process for producing a Mannich base comprising the steps of:
1. forming an isolated amine adduct;
2. subject the isolated amine adduct to a transamination reaction with a Mannich base.

20. The process of claim 19, wherein the isolated amine adduct is formed by reacting (a) an amine compound containing at least three active amine hydrogens with (b) an epoxide compound, there being an excess of (a) relative to reactive groups of components (a) and (b), and thereafter separating off the excess amine compound to yield an adduct isolated from free amines.

21. The process of claim 20, wherein the epoxide compound is a monofunctional glycidyl ether.

22. The process of claim 20, wherein the amine compound is a polyalkylenamine.

23. The process of claim 22, wherein the amine compound is a polyethylenepolyamine.

24. The process of claim 20, wherein the epoxide compound is added to a 1.5 to 8 molar excess of the amine component.

25. The process of claim 24, wherein the epoxide compound is added to a 2 to 3 molar excess of the amine component.

26. The process of claim 19, wherein the isolated amine adduct is subjected to a transamination reaction with a Mannich base of phenol, formaldehyde and dimethylamine.

27. The process of claim 26, wherein the Mannich base is tris(dimethylaminomethyl)phenol.

28. The process of claim 19, wherein the transamination reaction has a degree of exchange from 50% to 99%.

29. The process of claim 28, wherein the transamination reaction has degree of exchange from 60% to 95%.

30. The process of claim 28 or claim 29 wherein the Mannich base is trisdimethylaminomethylphenol.

31. A curable composition comprising:
(a) a Mannich based produced by the process according to claim 1 or claim 19; and
(b) an epoxy resin.
